(19) United States
(12) Patent Application Publication
(10) Pub. No.: US 2015/0049360 A1
(43) Pub. Date: Feb. 19, 2015

(54) CLOUD PRINTING SYSTEM AND METHOD USING NEAR FIELD COMMUNICATION

(71) Applicant: SAMSUNG ELECTRONICS CO., LTD., Suwon-si (KR)

(72) Inventors: Jae-in LEE, Suwon (KR); Dae-hyun KIM, Yongin (KR)

(73) Assignee: SAMSUNG ELECTRONICS CO., LTD., Suwon-si (KR)

(21) Appl. No.: 14/294,784

(22) Filed: Jun. 3, 2014

(30) Foreign Application Priority Data
Aug. 19, 2013 (KR) 10-2013-0098129

(51) Int. Cl. G06F 3/12

(52) U.S. Cl. CPC G06F 3/1292; G06F 3/1215; G06F 3/1237
USPC 358/1.15

(57) ABSTRACT

Provided is a cloud printing method using near field communication (NFC), the method comprising: selecting content for printing in a mobile terminal; requesting a print by the mobile terminal being NFC tagged to an image forming apparatus; transmitting the selected content to the cloud server via the mobile terminal; parallel rendering the content in the mobile terminal and the cloud server; generating print data by merging sets of content respectively rendered in the mobile terminal and the cloud server; and printing the print data in the image forming apparatus.

### CROSS-REFERENCE TO RELATED APPLICATIONS

This application claims the benefit of Korean Patent Application No. 10-2013-0098129, filed on Aug. 19, 2013, in the Korean Intellectual Property Office, the disclosure of which is incorporated herein in its entirety by reference.

### BACKGROUND

1. Field

One or more embodiments of the present invention relate to a cloud printing system and method using near field communication (NFC).

2. Description of the Related Art

With developments of mobile communication technologies and the widespread use of mobile communication terminals, mobile terminals, such as smart phones, tablet personal computers (PCs), and personal digital assistants (PDAs), are replacing the role of previous PCs. Accordingly, interests in a cloud printing technology using the mobile terminals are increasing.

Cloud printing refers to a technology for directly performing printing in a printer connected in a network, when mobile terminals, such as cellular phones or tablet PCs, request the print operation. In a cloud printing environment, a mobile terminal, a printer, and a cloud server are connected by a wireless network, and perform transmitting and receiving of information with respect to printing.

In detail, when the mobile terminal identifies content stored in the cloud server and requests a print of the content, the cloud server transmits the content for which the print is requested to the printer that performs the print of the content. Or, when a print for content stored in the mobile terminal is requested, the mobile terminal transmits the content to the cloud server, and, the cloud server transmits the content to the printer and requests the print of the content.

Meanwhile, in cloud printing, as data transmission and reception are essential, a printing speed and a printing quality contradict each other. To increase the printing quality, an amount of data that is transmitted should be reduced, and thus, the printing speed decreases. On the contrary, to increase the printing speed, the amount of data that is transmitted should be increased, and thus, the printing quality decreases

### SUMMARY

Additional aspects and/or advantages will be set forth in part in the description which follows and, in part, will be apparent from the description, or may be learned by practice of the invention.

One or more embodiments of the present invention include a method of increasing both a printing speed and a printing quality in a cloud printing system using near field communication (NFC).

Additional aspects will be set forth in part in the description which follows and, in part, will be apparent from the description, or may be learned by practice of the presented embodiments.

According to one or more embodiments of the present invention, a cloud printing method using near field communication (NFC) includes: selecting content for printing in a mobile terminal; requesting a print by the mobile terminal being NFC tagged to an image forming apparatus; transmitting the selected content to a cloud server via the mobile terminal; parallel rendering the content in the mobile terminal and the cloud server; generating print data by merging sets of the content respectively rendered in the mobile terminal and the cloud server; and printing the print data in the image forming apparatus.

The parallel rendering of the content may include rendering a part of the content in the mobile terminal and rendering the other part of the content in the cloud server.

Users may respectively set the part of the content to be rendered in the mobile terminal and the other part of the content to be rendered in the cloud server.

The parallel rendering of the content may include rendering a part of the content that has a capacity the same as or larger than a predetermined criterion in the mobile terminal and rendering the other part of the content in the cloud server.

The parallel rendering of the content may include rendering a part of the content that relates to an image in the mobile terminal and rendering the other part of the content that relates to a text and a vector in the cloud server.

The transmitting of the selected content includes transmitting only a part of the content that is to be rendered in the cloud server.

The generating of the print data may include generating print data by receiving rendered content from the cloud server and merging the received content with content rendered in the mobile terminal.

The printing of the print data may include: displaying a preview of the print data in the mobile terminal; transmitting the print data to the image forming apparatus via the mobile terminal, when an input of a confirmation of the preview is received from users; and printing the received print data via the image forming apparatus.

The printing of the print data may include: transmitting the print data to the cloud server via the mobile terminal and storing the received print data in the cloud server; connecting the cloud server and displaying a preview of the stored print data via the image forming apparatus; transmitting the print data to the image forming apparatus via the cloud server, when an input of a confirmation of the preview is received from users; and printing the received print data via the image forming apparatus.

According to one or more embodiments of the present invention, a cloud printing system using near field communication (NFC) includes: a mobile terminal that includes an NFC module and receives an input of a selection of content for printing; a cloud server for parallel rendering the content along with the mobile terminal; and an image forming apparatus including an NFC module, wherein, when the mobile terminal is NFC tagged to the image forming apparatus, the mobile terminal transmits the content to the cloud server, and, the image forming apparatus prints print data generated by parallel rendering the content in the mobile terminal and the cloud server and merging sets of content respectively rendered in the mobile terminal and the cloud server.

The mobile terminal may render a part of the content and the cloud server may render the other part of the content.

Users may respectively set the part of the content to be rendered in the mobile terminal and the other part of the content to be rendered in the cloud server.

The mobile terminal may render a part of the content that has a capacity the same as or larger than a predetermined criterion, and, the cloud server may render the other part of the content.

The mobile terminal may render a part of the content that relates to an image and the cloud server may render the other part of the content that relates to a text and a vector.

The mobile terminal may transmit only a part of the content that is to be rendered in the cloud server.

The mobile terminal may generate the print data by receiving rendered content from the cloud server and merging the received content with content rendered in the mobile terminal.

The mobile terminal may display a preview of the print data, and, when an input of a confirmation of the preview is received from users, may transmit the print data to the image forming apparatus.

The mobile terminal may transmit and store the print data in the cloud server, the image forming apparatus may display a preview of the print data stored in the cloud server, and, when an input of a confirmation of the preview is received from users, the cloud server may transmit the stored print data to the image forming apparatus.

A cloud printing method using near field communication (NFC), the method including: selecting content for printing in a mobile terminal; requesting a print by the mobile terminal being NFC tagged to an image forming apparatus; dividing the selected content into a first portion of the content to be rendered in the mobile terminal and a second portion of the content to be rendered in the cloud server; transmitting the second portion of the content to a cloud server; rendering the first portion of the content in the mobile; generating print data by merging sets of the content respectively rendered in the mobile terminal and the cloud server; and transmitting the generated print data to the NFC tagged image forming apparatus.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view illustrating a cloud printing system using near field communication (NFC) according to an embodiment of present invention;

FIGS. 2A through 2H are views illustrating operations of a could printing method using NFC according to an embodiment of the present invention;

FIGS. 3 and 4 are views illustrating operations of components included in a cloud printing system using NFC according to an embodiment of the present invention;

FIG. 5 is a view illustrating a configuration of a mobile terminal, according to an embodiment of the present invention;

FIG. 6 is a view illustrating a configuration of an image forming apparatus, according to an embodiment of the present invention; and

FIGS. 7 through 9 are flowcharts illustrating operations of a cloud printing method using NFC according to an embodiment of the present invention.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

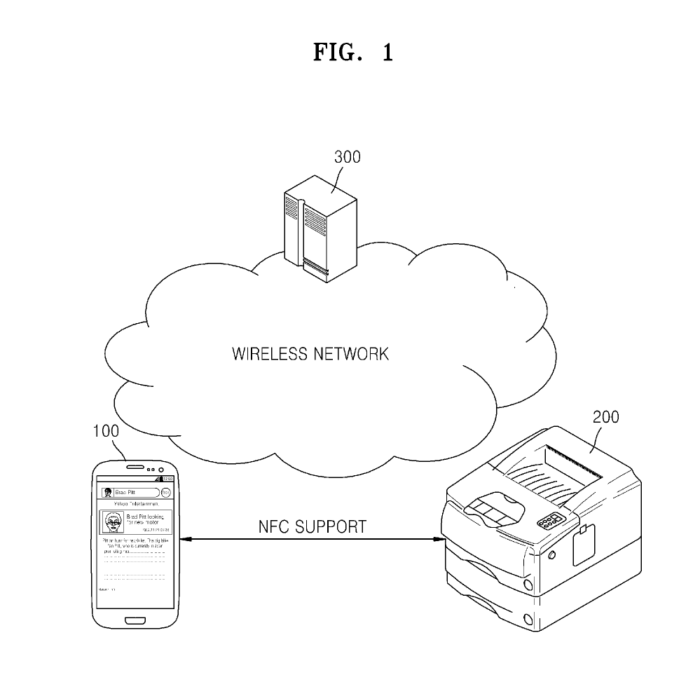

FIG. 1 is a view illustrating a cloud printing system using near field communication (NFC) according to an embodiment of present invention. Referring to FIG. 1, the cloud printing system using NFC according to an embodiment of the present invention may include a mobile terminal 100, a multi-function printer 200, and a cloud server 300. The mobile terminal 100 and the cloud server 300, or the cloud server 300 and the multi-function printer 200 may be connected by a wireless network. Also, the mobile terminal 100 and the multi-function printer 200 support the NFC.

The mobile terminal 100 may be an information processing terminal that may perform wireless communications, such as cellular phones, tablet personal computers (PCs), or personal digital assistants (PDAs). The multi-function printer 200 may be replaced by any kind of an image forming apparatus that has a print function, including a printer.

The NFC, that the mobile terminal 100 and the multi-function printer support, may be active NFC or passive NFC, and, the mobile terminal 100 and the multi-function printer 200 may include at least one of an NFC chip, an NFC tag, and an NFC reader. Hereinafter, it will be supposed that the mobile terminal 100 includes the NFC chip and the multi-function printer 200 includes the NFC tag in which information necessary for cloud printing is stored, so that the passive NFC is performed between the mobile terminal 100 and the multi-function printer 200. Here, in the NFC tag, information of the multi-function printer 200, such as a MAC address of the multi-function printer 200 and the name of the device, is stored.

Content for printing is transmitted among the mobile terminal 100, the multi-function printer 200, and the cloud server 300 via the wireless network. The mobile terminal 100 may request a print or obtain the information of the multi-function printer 200 that is necessary for cloud printing, by using the NFC with respect to the multi-function printer 200. Also, when a connection including a Wi-Fi direct or a bluetooth between the mobile terminal 100 and the multi-function printer 200 is configured by the mobile terminal 100 being NFC tagged to the multi-function printer 200, the mobile terminal 100 may directly transmit the content for printing to the multi-function printer 200.

To print the content, print data should be generated by rendering the content. In the cloud printing system according to an embodiment of the present invention, the mobile terminal 100 along with the cloud server 300 may perform parallel rendering. That is, the mobile terminal 100 and the cloud server 300 respectively perform rendering of a part and the other part of the content, and, the print data is generated by merging sets of content respectively rendered.

In general, a printing speed is affected by the time during which the rendering is performed prior to the printing. According to an embodiment of the present invention, by performing the parallel rendering, the rendering time is reduced, and thus, the printing speed is increased. Additionally, as the rendering is performed by separating parts of the content, a quality of the rendering may be increased in a relatively short period of time.

Users may pre-set to separate parts of the content so that a part is rendered in the mobile terminal 100 and the other part is rendered in the cloud server 300, in order to maximize an effect of increasing the printing speed and a printing quality.

Like this, by using the cloud printing system using NFC according to an embodiment of the present invention, the mobile terminal 100 and the cloud server 300 may parallel render the content for printing, thereby increasing both the printing speed and the printing quality.

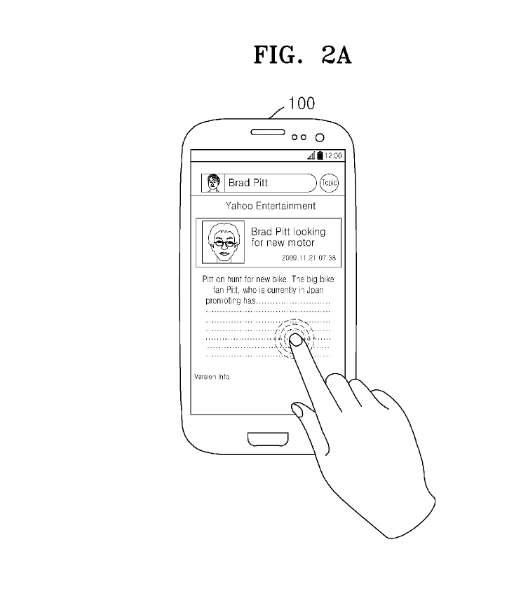

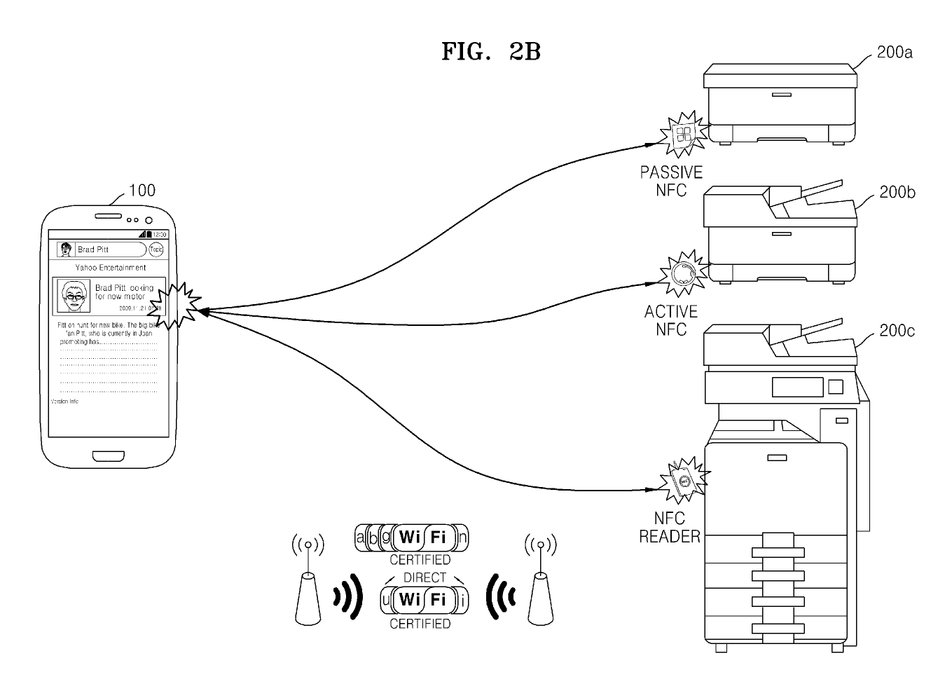

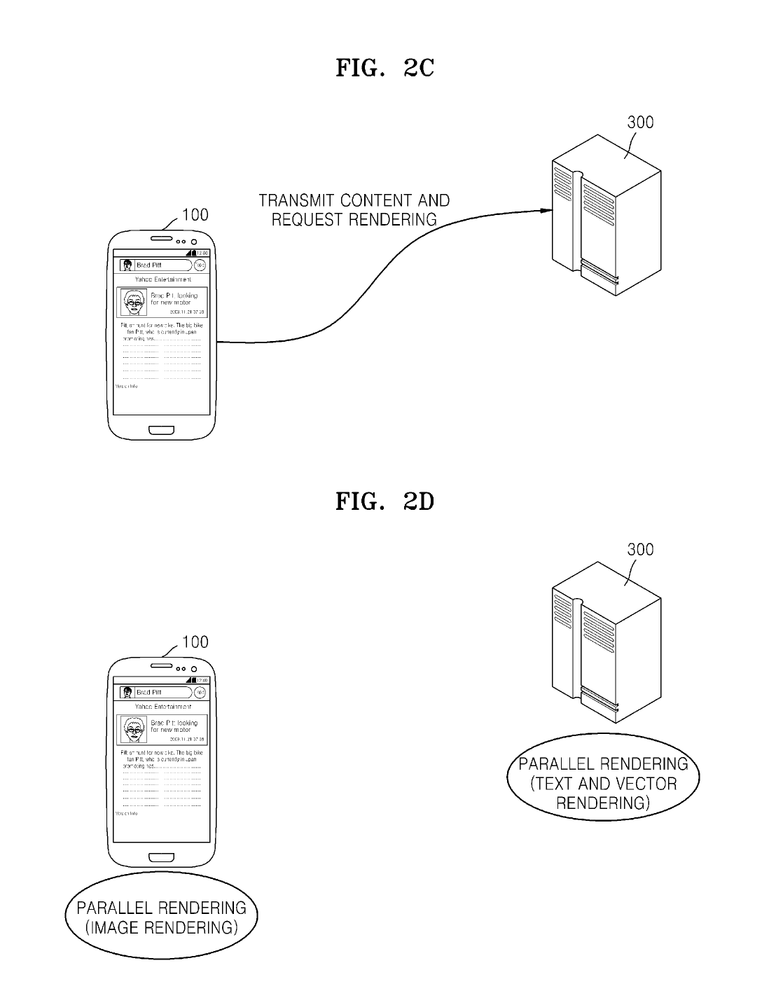

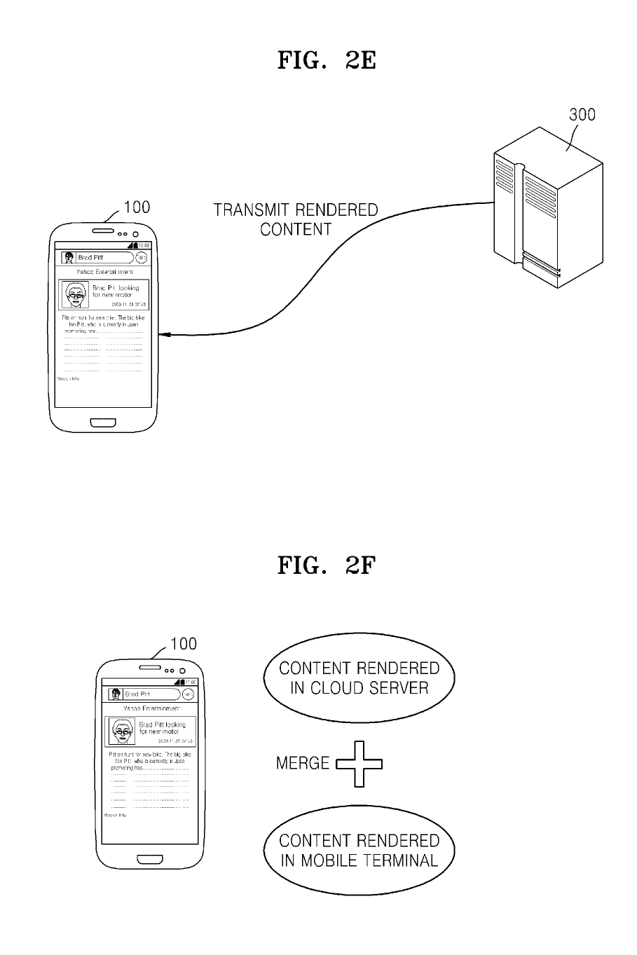

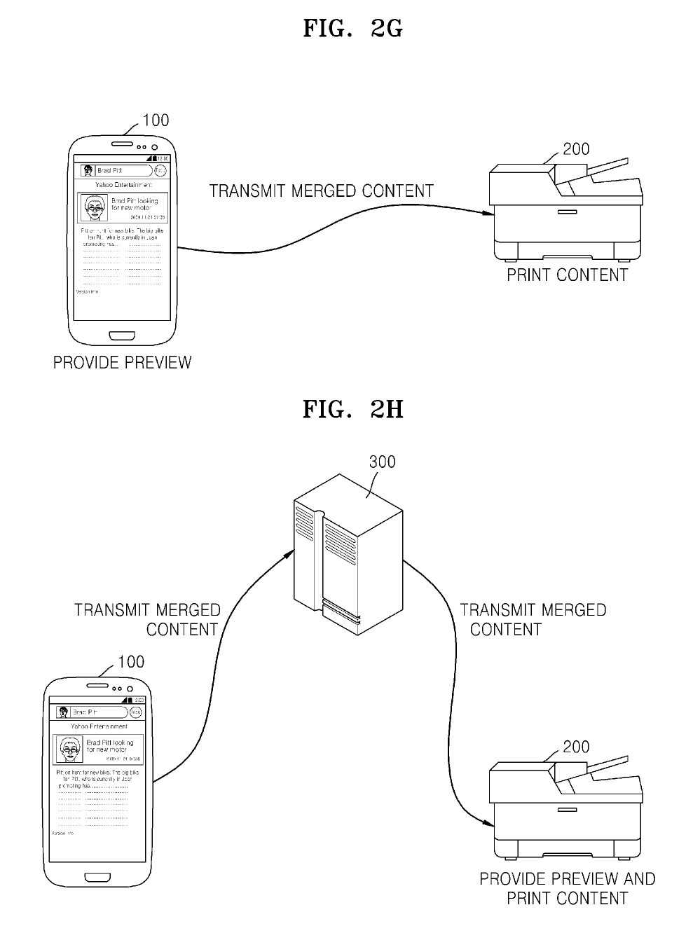

Hereinafter operations of a cloud printing method using NFC according to an embodiment of the present invention will be described in detail, in reference to FIGS. 2A through 2H.

FIGS. 2A through 2H are views illustrating operations of a could printing method using NFC according to an embodiment of the present invention.

FIG. 2A is a view illustrating an operation of selecting content for printing in the mobile terminal 100, according to an embodiment of the present invention. Users may select to print any one of a text and an image of content stored in the mobile terminal 100. Also, the users may identify content stored in the cloud server 300 on a screen of the mobile terminal 100 and request a print. Furthermore, the users may select a web page displayed through a web browser of the mobile terminal 100 as the content for printing. Hereinafter, a case in which any one of the text and the image of the content stored in the mobile terminal 100 is selected and printed, will be described.

FIG. 2B is a view illustrating an operation of the mobile terminal 100 being NFC tagged to the multi-function printer 200a, 200b, and 200c, according to an embodiment of the present invention. If there are a plurality of the multi-function printers 200a, 200b, and 200c as illustrated in FIG. 2B, users with the mobile terminal 100 may move to the multi-function printer 200a, 200b, and 200c in which the users want to perform a print operation, and may perform NFC tagging, thereby both selecting the multi-function printer 200a, 200b, and 200c for performing the print operation and requesting the print.

When the mobile terminal 100 is NFC tagged to any one of the multi-function printers 200a, 200b, and 200c, the mobile terminal determines that there is the request of the print and transmits selected content to the cloud server 300. In detail, the mobile terminal 100 confirms that the apparatus to which the tagging is performed is the multi-function printer 200a, 200b, and 200c having a printing function, by using information obtained, by the NFC tagging, from the NFC tag of the multi-function printer 200a, 200b, and 200c, and, accordingly, the mobile terminal 100 starts a process for printing.

In addition, if the mobile terminal 100 is NFC tagged to any one of the multi function printers 200a, 200b, and 200c, the mobile terminal 100 may obtain the information necessary for performing cloud printing. By using the obtained information, the wireless connection including the Wi-Fi direct may be configured between the mobile terminal 100 and the tagged multi-function printer 200a, 200b, and 200c. After the rendering is completed, the mobile terminal 100 may directly transmit the print data to the multi-function printer 200a, 200b, and 200c via the Wi-Fi direct connection between the mobile terminal 100 and the multi-function printer 200a, 200b, and 200c.

FIG. 2C is a view illustrating an operation of the mobile terminal 100 transmitting the content for printing to the cloud server 300 and requesting the rendering, according to an embodiment of the present invention. Among the content including stored documents or images, the mobile terminal 100 transmits the content selected by users to the cloud server 300 and requests the rendering. Here, the mobile terminal 100 may transmit the entire part of the content for printing or only a part of the content for printing that is to be rendered in the cloud server 300.

If the mobile terminal 100 transmits only the part of the content that is to be rendered in the cloud server 300, transmission time is reduced, thereby increasing the printing speed. The effect of increasing the printing speed is larger, as a capacity of the other part of the content that is to be rendered in the mobile terminal 100, that is, the part except the part of the content that is to be rendered in the cloud server 300, is larger. Thus, to increase the printing speed, it is recommended that a part of the content having a large capacity is rendered in the mobile terminal 100 and only the other part of the content is transmitted to the cloud server 300.

For example, if the content for printing is indicated in a page description language (PDL), of the image, text, and vector included in the PDL, the capacity of the image is relatively large, and thus, the image is not transmitted to the cloud server 300 and is rendered directly in the mobile terminal 100. Also, in case of the text and vector, as the text and vector have relatively small capacities and a font may not be supplied in the mobile terminal 100, the text and vector are transmitted to the cloud server 300 and are rendered in the cloud server 300.

FIG. 2D is a view illustrating an operation of the mobile terminal 100 and the cloud server 300 parallel rendering, according to an embodiment of the present invention. As illustrated earlier in FIG. 2C, to maximize the printing speed and the printing quality, the mobile terminal 100 renders the image part of the content and the cloud server 300 renders the other part of the content, that is, the part relating to the text and vector. Of course, the users may arbitrarily set and change separating of parts of the content to be parallel rendered.

FIG. 2E is a view illustrating an operation of the cloud server 300 transmitting rendered content to the mobile terminal 100, according to an embodiment of the present invention. The cloud server 300, after completing the parallel rendering of allocated part of the content, transmits the rendered content to the mobile terminal 100 so as to be merged with content rendered in the mobile terminal 100.

FIG. 2F is a view illustrating an operation of the mobile terminal 100 merging the content parallel rendered, according to an embodiment of the present invention. The mobile terminal 100 generates the print data by merging the content that is rendered in the cloud server 300 and received from the cloud server 300, with the content rendered in the mobile terminal 100.

After the print data is generated by the merging of the parallel rendered content, the generated print data is transmitted to and printed in the multi-function printer 200. Here, the mobile terminal 100 may directly transmit the print data to the multi-function printer 200, or the print data may be transmitted from the mobile terminal 100 to the cloud server 300 that stores the transmitted print data, and again transmitted to the multi-function printer 200.

In addition, it may also be embodied in such a way that a preview of the generated print data may be provided to the users before performing printing, and, the printing may be performed if the users finally confirm the preview. Here, the preview may be displayed of the mobile terminal 100 and/or the multi-function printer 200.

FIGS. 2G and 2H are views illustrating operations of transmitting the print data, providing the preview, and performing the printing, according to embodiments of the present invention.

Referring to FIG. 2G, after the print data is generated by the merging of the parallel rendered content, the mobile terminal 100 displays the preview of the generated print data on a screen. If the users check the preview and confirm it, the mobile terminal 100 transmits the generated print data to the multi-function printer 200. The multi-function printer 200 prints the received print data, and the process is completed.

Meanwhile, referring to FIG. 2H, the mobile terminal 100 first transmits the generated print data to the cloud server 300 and stores the data in the cloud server 300. The cloud server 300 stores the received print data, and, when there is a request of a pull-print from the multi-function printer 200, transmits the print data to the multi-function printer 200. The multi-function printer 200 may display the preview of the print data stored in the cloud server 300 via a display panel included in the multi-function printer 200. If the final print request is input by the user's confirmation of the preview, the cloud server 300 transmits the print data to the multi-function printer 200, and, the multi-function printer 200 prints the received print data.

Like this, by parallel-rendering the content for printing in both the mobile terminal 100 and the cloud server 300, merging the rendered content, and then printing the content, the printing speed and the printing quality may be both increased.

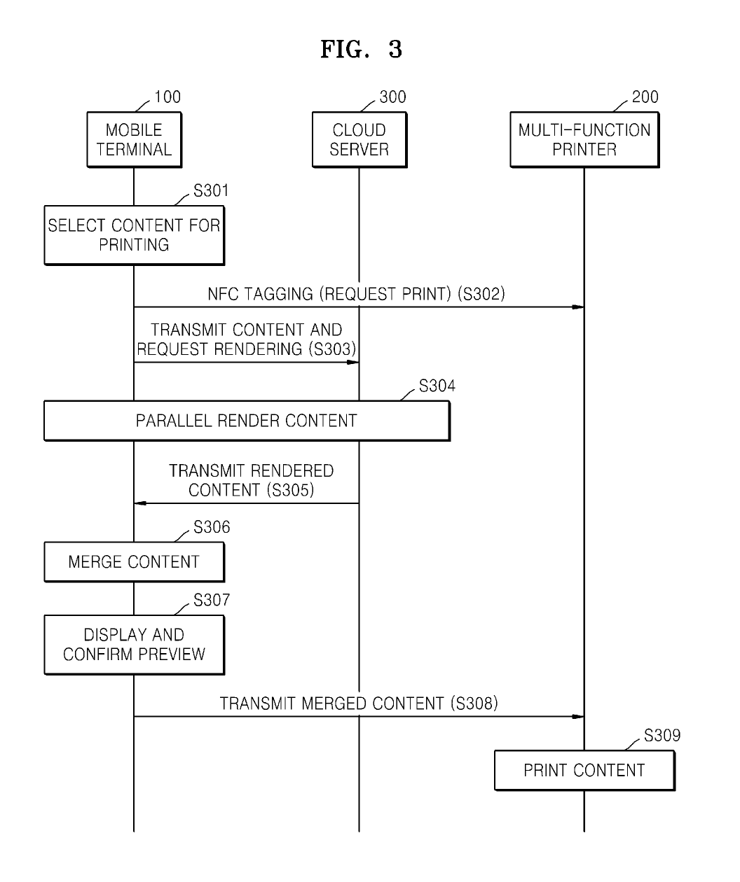

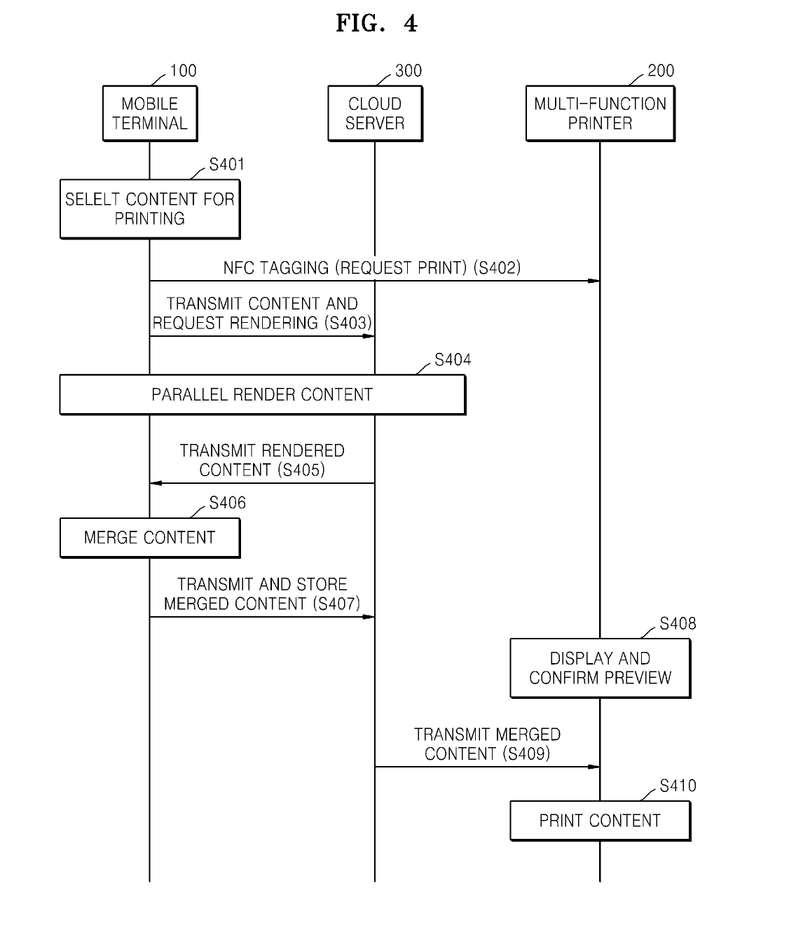

FIGS. 3 and 4 are views illustrating operations of components included in the cloud printing system using NFC according to embodiments of the present invention.

Referring to FIG. 3, in operation S301, the content for printing is selected in the mobile terminal 100. Here, the users may select to print any one of the text and the image of content stored in the mobile terminal 100. Also, the users may identify content stored in the cloud server 300 on the screen of the mobile terminal 100 and request a print. Moreover, the users may select a web page displayed through a web browser of the mobile terminal 100 as the content for printing. Hereinafter, a case in which any one of the text and the image of the content stored in the mobile terminal 100 is selected and printed, will be described.

In operation S302, the mobile terminal 100 is NFC tagged to the multi-function printer 200. The users with the mobile terminal 100 may move to the multi-function printer 200 in which the users want to perform a print operation, and may perform NFC tagging, thereby both selecting the multi-function printer 200 for performing the print operation and requesting the print. Also, when the mobile terminal 100 is NFC tagged to the multi-function printer 200, the mobile terminal 100 obtains information necessary for performing cloud printing. The wireless connection, such as the Wi-Fi direct, may be configured between the mobile terminal 100 and the tagged multi-function printer 200, by using the obtained information. After the rendering is completed, the mobile terminal 100 may directly transmit the print data to the multi-function printer 200 via the Wi-Fi direct connection between the mobile terminal 100 and multi-function printer 200.

In operation S303, the mobile terminal 100 transmits the content to the cloud server 300 and requests the rendering. Among the content including stored documents or images, the mobile terminal 100 transmits the content selected by users to the cloud server 300 and requests the rendering. Here, the mobile terminal 100 may transmit the entire part of the content for printing or only a part of the content for printing that is to be rendered in the cloud server 300.

If the mobile terminal 100 transmits only the part of the content that is to be rendered in the cloud server 300, transmission time is reduced, thereby increasing the printing speed. The effect of increasing the printing speed is larger, as a capacity of the other part of the content that is to be rendered in the mobile terminal 100, that is, the part except the part of the content that is to be rendered in the cloud server 300, is larger. Thus, to increase the printing speed, it is recommended that a part of the content having a large capacity is rendered in the mobile terminal 100 and only the other part of the content is transmitted to the cloud server 300.

For example, if the content for printing is indicated in a page description language (PDL), of the image, text, and vector included in the PDL, the capacity of the image is relatively large, and thus, the image is not transmitted to the cloud server 300 and is rendered directly in the mobile terminal 100. Also, in case of the text and vector, as the text and vector have relatively small capacities and a font may not be supplied in the mobile terminal 100, the text and vector are transmitted to the cloud server 300 and are rendered in the cloud server 300. Of course, the users may arbitrarily set and change separating of parts of the content to be parallel rendered.

In operation S304, the mobile terminal 100 and the cloud server 300 respectively perform the parallel rendering of allocated parts of the content. After the parallel rendering is completed, the cloud server 300 transmits the rendered content to the mobile terminal 100 in operation S305, and, the mobile terminal 100 receiving the rendered content merge the content respectively rendered in the mobile terminal 100 and the cloud server 300 in operation S306.

In operation S307, the mobile terminal 100 displays the preview of the merged content and receives the input of the confirmation from the users. If the users confirm the preview of the merged data, the mobile terminal 100 transmits the merged content to the multi-function printer 200 in operation S308, and, the multi-function printer 200 prints the received content in operation S309.

Operations of S401 through S406 according to an embodiment illustrated in FIG. 4 are identical with the operations of S301 through S306 according to the embodiment illustrated in FIG. 3, and thus, descriptions with respect to the operations of S401 through S406 will be omitted and only different operations will be described.

Referring to FIG. 4, after the parallel rendering and merging of the content are completed, the mobile terminal 100 transmits and stores the merged content in the cloud server 300 in operation S407. When the multi-function printer 200 displays the preview of the merged content and the users confirm the preview in operation S408, the cloud server 300 transmits the merged content to the multi-function printer 200 in operation S409. In operation S410, the multi-function printer 200 prints the merged content.

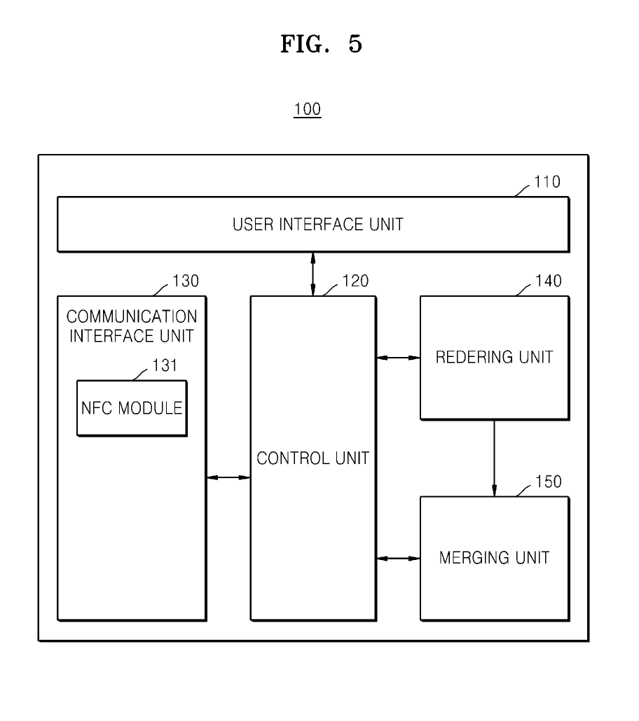

FIG. 5 is a view illustrating a configuration of the mobile terminal 100, according to an embodiment of the present invention.

Referring to FIG. 5, the mobile terminal 100 according to an embodiment of the present invention may include a user interface unit 110, a control unit 120, a communication interface unit 130, an NFC module 131, a rendering unit 140, and a merging unit 150.

The user interface unit 110 may display content to users and receive an input of a selection of the content. For example, the user interface unit 110 may display the content on a touch screen of the mobile terminal 100 and receive the input of the selection of the content for printing by a touch input. Also, the user interface unit 110 may display the preview of the print data for the users to indentify.

The control unit 120 controls operations of the components included in the mobile terminal 100. In particular, the control unit 120 according to an embodiment of the present invention controls the rendering unit 130 and the merging unit 150 for performing the parallel rendering and merging of the content.

The communication interface unit 130 may perform communications with the cloud server 300 via the wireless network, and the NFC module 131 may perform cloud printing by the NFC tagging to the multi-function printer 200 supporting the NFC.

The rendering unit 140 performs the parallel rendering of a part of the content for printing, and receives from the cloud server 300 data that is the result of performing the rendering of the other part of the content for printing. The merging unit 150 merges the rendered content and generates the print data.

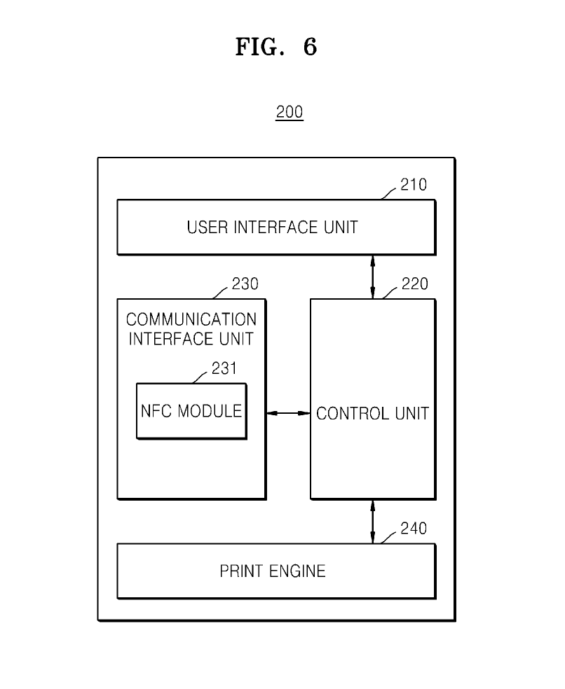

Meanwhile, the control unit 120 may determine according to which criterion parts of the content may be separated for the parallel rendering and may control the parallel rendering. This may be performed according to a criterion predetermined by the users. FIG. 6 is a view illustrating a configuration of the image forming apparatus, according to an embodiment of the present invention, the multi-function printer 200 according to an embodiment of the present invention may include the user interface unit 210, the control unit 220, the communication interface unit 230, the NFC module 231, and a print engine 240.

The user interface unit 210 may provide the preview of the print data to the users. The control unit 220 is a component for controlling an operation of each of the components of the multi-function printer 200, and more particularly, controls the NFC connection with the mobile terminal 100 and the pull-print operation of the print data stored in the cloud server 300. The communication interface unit 230 and the NFC module 231 perform the wireless network and the NFC connection, respectively. The print engine 240 prints the print data.

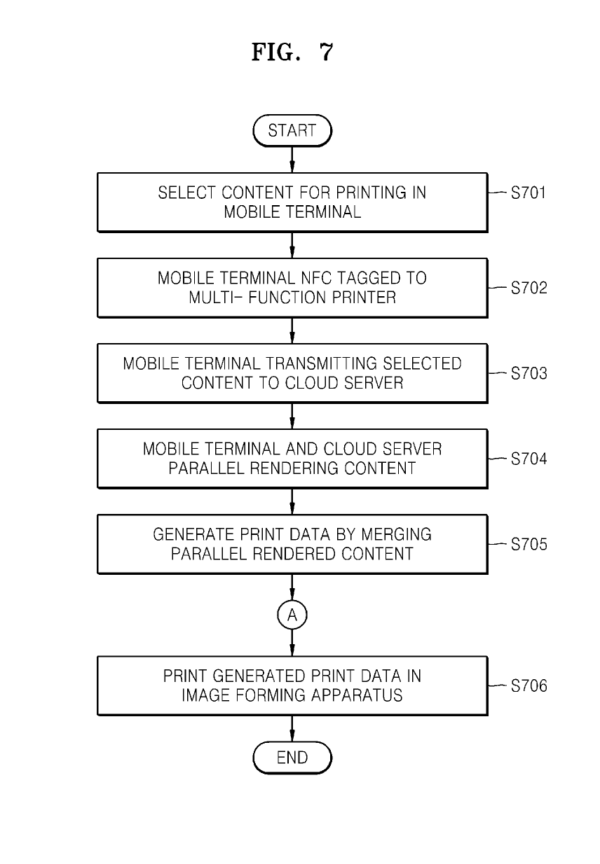

FIGS. 7 through 9 are flowcharts illustrating operations of the cloud printing method using NFC according to an embodiment of the present invention.

Referring to FIG. 7, the content for printing is selected by users in the mobile terminal 100, in operation S701. Here, the users may select to print any one of the text and the image of content stored in the mobile terminal 100. Also, the users may identify content stored in the cloud server 300 on the screen of the mobile terminal 100 and request a print. In addition, the users may select a web page displayed through a web browser of the mobile terminal 100 as the content for printing. Hereinafter, a case in which any one of the text and the image of the content stored in the mobile terminal 100 is selected and printed, will be described.

When the mobile terminal 100 is NFC tagged to the multi-function printer 200 in operation S702, the mobile terminal 100 transmits the content selected in operation S701 to the cloud server 300 in operation S703. Here, the mobile terminal 100 may transmit only a part of the content that is to be rendered in the cloud server 300 thereby increasing the printing speed.

In operation S704, the mobile terminal 100 and the cloud server 300 perform the parallel rendering of the selected content. Here, a part of the content that has a large capacity is not transmitted to the cloud server 300 and is directly rendered in the mobile terminal 100, and the other part of the content is transmitted to the cloud server 300 and is rendered in the cloud server 300, thereby increasing both the printing speed and the printing quality.

For example, if the content for printing is indicated in a page description language (PDL), of the image, text, and vector included in the PDL, the capacity of the image is relatively large, and thus, the image is not transmitted to the cloud server 300 and is rendered directly in the mobile terminal 100. Also, in case of the text and vector, as the text and vector have relatively small capacities and a font may not be supplied in the mobile terminal 100, the text and vector are transmitted to the cloud server 300 and are rendered in the cloud server 300. Of course, the users may arbitrarily set and change separating of parts of the content to be parallel rendered.

After the parallel rendering is completed, the print data is generated by merging the rendered content, in operation S705, and in operation 706, the image forming apparatus prints the print data.

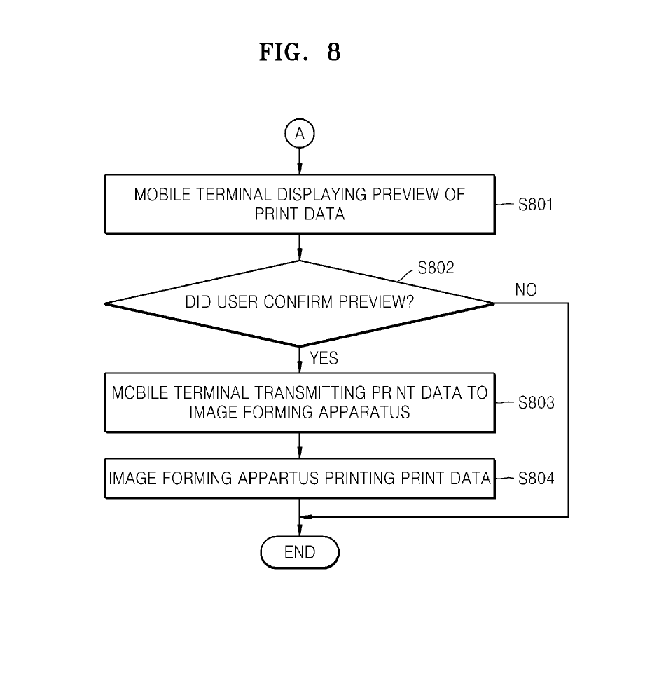

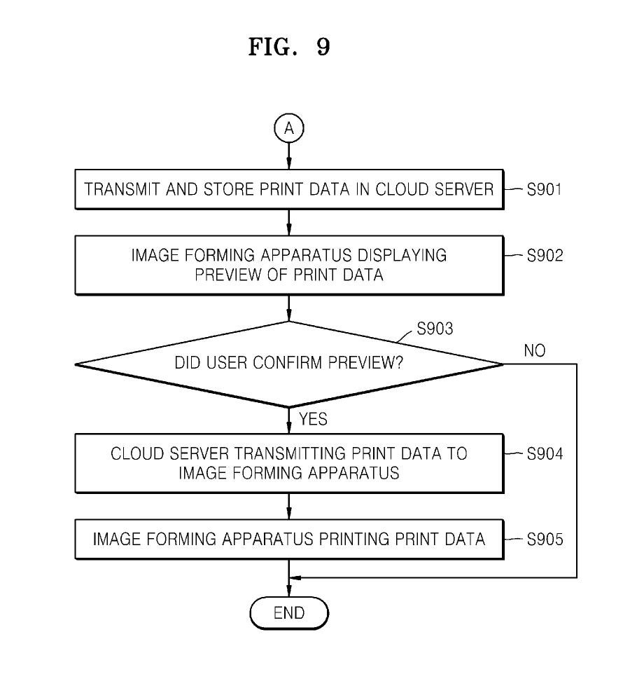

FIGS. 8 and 9 illustrate detailed operations of the operation S706 of the image forming apparatus printing the print data, according to embodiments of the present invention that are different from each other.

Referring to FIG. 8, the mobile terminal 100 displays the preview of the print data in operation S801. In operation S802, the mobile terminal 100 determines whether the users confirm the preview. If it is determined that the users confirm the preview, it proceeds to operation S803 in which the mobile terminal 100 transmits the print data to the image forming apparatus, and, in operation S804, the image forming apparatus prints the print data. On the contrary, when the users do not confirm the preview in operation S802, the process is completed.

Referring to FIG. 9, the mobile terminal 100 transmits the print data to the cloud server 300 and stores the print data in the cloud server 300 in operation S901. Next, in operation S902, the image forming apparatus, the multi function printer 200, displays the preview of the print data stored in the cloud server 300, and then, in operation S903, the image forming apparatus determines whether the users confirm the preview. If it is determined that the users confirm the preview, it proceeds to operation S904 in which the cloud server 300 transmits the print data to the image forming apparatus, and, in operation S905, the image forming apparatus 200 prints the print data. On the contrary, if it is determined that the users do not confirm the preview in operation S903, the process is completed.

Like this, by parallel rendering the content for printing in the mobile terminal 100 and the cloud server 300, merging the rendered content, and then printing, the printing speed and the printing quality may be both increased.

The invention can also be embodied as program instructions on a computer readable recording medium. The non-transitory computer-readable medium may include program instructions, data files, data structures, and/or combinations thereof. Program instructions that are written to the medium may be specially designed and constructed for the present invention or may be known to those skilled in computer software. Examples of the computer readable recording medium include magnetic media, such as a hard disk, a floppy disk, and a magnetic tape, optical media, such as a CD-ROM and a DVD, magneto-optical media, such as a floptical disk, and hardware devices particularly constructed for storing and executing program instructions, such as a ROM, a RAM, and a flash memory. Examples of the program instructions include not only machine language codes generated by a compiler, but also high-level language codes that may be executed on a computer via an interpreter.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claim.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A cloud printing method using near field communication (NFC), the method comprising:
selecting content for printing in a mobile terminal;
requesting a print by the mobile terminal being NFC tagged to an image forming apparatus;
transmitting the selected content to a cloud server via the mobile terminal;
rendering the content in parallel in the mobile terminal and the cloud server;
generating print data by merging sets of the content respectively rendered in the mobile terminal and the cloud server; and
printing the print data in the image forming apparatus.

2. The method of claim 1, wherein the parallel rendering of the content comprises rendering a part of the content in the mobile terminal and the other part of the content in the cloud server.

3. The method of claim 2, wherein users respectively set the part of the content to be rendered in the mobile terminal and the other part of the content to be rendered in the cloud server.

4. The method of claim 2, wherein the parallel rendering of the content comprises rendering a part of the content that has a capacity the same as or larger than a predetermined criterion in the mobile terminal and the other part of the content in the cloud server.

5. The method of claim 2, wherein the parallel rendering of the content comprises rendering a part of the content that relates to an image in the mobile terminal and the other part of the content that relates to a text and a vector in the cloud server.

6. The method of claim 1, wherein the transmitting of the selected content comprises transmitting only a part of the content that is to be rendered in the cloud server.

7. The method of claim 1, wherein the generating of the print data comprises generating print data by receiving rendered content from the cloud server and merging the received content with content rendered in the mobile terminal.

8. The method of claim 7, wherein the printing of the print data comprises displaying a preview of the print data in the mobile terminal; transmitting the print data to the image forming apparatus via the mobile terminal, when an input of a confirmation of the preview is received from users; and printing the received print data via the image forming apparatus.

9. The method of claim 7, wherein the printing of the print data comprises transmitting the print data to the cloud server via the mobile terminal and storing the received print data in the cloud server; connecting the cloud server and displaying a preview of the stored print data via the image forming apparatus; transmitting the print data to the image forming apparatus via the cloud server, when an input of a confirmation of the preview is received from users; and printing the received print data via the image forming apparatus.

10. A computer readable medium having embodied thereon a program for executing the method of claim 1.

11. A cloud printing system using near field communication (NFC), the system comprising:
a mobile terminal that includes an NFC module and receives an input of a selection of content for printing;
a cloud server for parallel rendering the content along with the mobile terminal; and
an image forming apparatus including an NFC module,
wherein, when the mobile terminal is NFC tagged to the image forming apparatus, the mobile terminal transmits the content to the cloud server, and the image forming apparatus prints print data generated by parallel rendering and merging the content via the mobile terminal and the cloud server.

12. The system of claim 11, wherein the mobile terminal renders a part of the content and the cloud server renders the other part of the content.

13. The system of claim 12, wherein users respectively set the part of the content to be rendered in the mobile terminal and the other part of the content to be rendered in the cloud server.

14. The system of claim 12, wherein the mobile terminal renders a part of the content that has a capacity the same as or larger than a predetermined criterion, and, the cloud server renders the other part of the content.

15. The system of claim 12, wherein the mobile terminal renders a part of the content that relates to an image and the cloud server renders the other part of the content that relates to a text and a vector.

16. The system of claim 11, wherein the mobile terminal transmits only a part of the content that is to be rendered in the cloud server.

17. The system of claim 11, wherein the mobile terminal generates the print data by receiving rendered content from the cloud server and merging the received content with content rendered in the mobile terminal.

18. The system of claim 17, wherein the mobile terminal displays a preview of the print data, and, when an input of a confirmation of the preview is received from users, transmits the print data to the image forming apparatus.

19. The system of claim 17, wherein the mobile terminal transmits and stores the print data in the cloud server, the image forming apparatus displays a preview of the print data stored in the cloud server, and, when an input of a confirmation of the preview is received from users, the cloud server transmits the stored print data to the image forming apparatus.

20. A cloud printing method using near field communication (NFC), the method comprising:
selecting content for printing in a mobile terminal;
requesting a print by the mobile terminal;
dividing the selected content into a first portion of the content to be rendered in the mobile terminal and a second portion of the content to be rendered in the cloud server;
transmitting the second portion of the content to a cloud server;
rendering the first portion of the content in the mobile;
generating print data by merging sets of the content respectively rendered in the mobile terminal and the cloud server; and
transmitting the generated print data to an NFC tagged image forming apparatus.
